(19) United States
(12) Patent Application Publication
(10) Pub. No.: US 2022/0120203 A1
(43) Pub. Date: Apr. 21, 2022

(54) HONEYCOMB STRUCTURE AND EXHAUST GAS PURIFYING DEVICE

(71) Applicant: NGK INSULATORS, LTD., Nagoya-City (JP)

(72) Inventors: Shuichi ICHIKAWA, Nagoya-City (JP); Takuya ISHIHARA, Tsushima-City (JP); Yukio MIYAIRI, Nagoya-City (JP); Masaaki MASUDA, Nagoya-City (JP)

(73) Assignee: NGK INSULATORS, LTD., Nagoya-City (JP)

(21) Appl. No.: 17/646,018

(22) Filed: Dec. 27, 2021

Related U.S. Application Data
(63) Continuation of application No. PCT/JP2020/015711, filed on Apr. 7, 2020.

(30) Foreign Application Priority Data
Sep. 11, 2019 (JP) 2019-165762

(51) Int. Cl. F01N 3/022; F01N 3/027

(52) U.S. Cl. CPC F01N 3/0222; F01N 3/0224; F01N 3/027; F01N 2370/30; F01N 2330/02; F01N 2330/08; F01N 2240/16; F01N 2330/06

(57) ABSTRACT

A pillar shaped honeycomb structure includes: an outer peripheral wall; and a porous partition wall disposed on an inner side of the outer peripheral wall, the partition wall defining a plurality of cells, each of the plurality of cells extending from one end face to the other end face to form a flow path. The partition wall is a porous body containing aggregates and binding materials binding the aggregates. At least a part of the aggregates includes magnetic particles.

### FIELD OF THE INVENTION

The present invention relates to a honeycomb structure and an exhaust gas purifying device.

### BACKGROUND OF THE INVENTION

Exhaust gases from motor vehicles typically contain harmful components such as carbon monoxide, hydrocarbons and nitrogen oxides and/or fine particles of carbon or the like as a result of incomplete combustion. From the viewpoint of reducing health hazards to a human body, there is an increasing need for reducing harmful gas components and fine particles in exhaust gases from motor vehicles.

However, at present, these harmful components are discharged, in particular during a period immediately after an engine is started, i.e., a period during which a catalyst temperature is lower and a catalytic activity is insufficient. Therefore, the harmful components in the exhaust gas may be discharged without being purified by the catalyst before reaching the catalyst activation temperature. In order to satisfy such a need, it is necessary to reduce emission as much as possible, which is discharged without being purified by a catalyst before reaching the catalyst activation temperature. For example, measures using an induction heating technique are known in the art.

As such a technique, Patent Literature 1 proposes a technique for producing a honeycomb structure by mixing magnetic metal particles with a forming aid and sintering them. Patent Literature 2 proposes a technique for mixing metallic particles with ceramics and placing the resulting mixture in cell walls of a honeycomb structure. Patent Literature 3 proposes a technique for supporting magnetic particles on surfaces of cells of a honeycomb structure of a filter structure.

According to the techniques of Patent Literatures 1 to 3, a current can be passed through the coil on an outer periphery of the honeycomb to increase a temperature of a magnetic substance by induction heating, and its heat can increase a temperature of the honeycomb.

### CITATION LIST

### Patent Literatures

[Patent Literature 1] U.S. Pat. No. 5,403,540
[Patent Literature 2] U.S. Pat. No. 9,488,085
[Patent Literature 3] Japanese Patent No. 6243041 B

### SUMMARY OF THE INVENTION

There is need for further improvement of reduction of harmful gas components and fine particles in an automobile exhaust gas for the honeycomb structures using induction heating, as disclosed in Patent Literature 1 and Patent Literature 2.

Further, the supporting of the magnetic particles on the surfaces of the cells of the honeycomb structure as disclosed in Patent Literature 3 causes a problem of increasing a pressure loss accordingly.

In view of the above circumstances, an object of the present invention is to provide a honeycomb structure and an exhaust gas purifying device, which can burn out and remove carbon fine particles and the like by induction heating or heat a catalyst to be supported on the honeycomb structure, and which can satisfactorily suppress a pressure loss.

As a result of intensive studies, the present inventors have found that the above problems can be solved by forming a partition wall from a porous body having aggregates linked by binding materials, and making at least a part of the aggregates of magnetic particles, in a pillar shaped honeycomb structure. That is, the present invention is specified as follows:

(1) A pillar shaped honeycomb structure, comprising:

an outer peripheral wall; and

a porous partition wall disposed on an inner side of the outer peripheral wall, the partition wall defining a plurality of cells, each of the plurality of cells extending from one end face to the other end face to form a flow path, wherein the partition wall is a porous body comprising aggregates and binding materials binding the aggregates, and

wherein at least a part of the aggregates comprises magnetic particles.

(2) An exhaust gas purifying device, comprising:

the honeycomb structure according to (1);

a coil wiring that spirally surrounds an outer periphery of the honeycomb structure; and

a metal pipe for housing the honeycomb structure and the coil wiring.

It is possible to provide a honeycomb structure and an exhaust gas purifying device, which can burn out and remove carbon fine particles and the like by induction heating or heat a catalyst to be supported on the honeycomb structure, and which can satisfactorily suppress a pressure loss.

### BRIEF DESCRIPTION OF THE DRAWINGS

FIG. 1 is a schematic external view of a pillar shaped honeycomb structure according to an embodiment of the present invention;

FIG. 2 is a schematic cross-sectional view perpendicular to an axial direction of a honeycomb structure according to an embodiment of the present invention;

FIG. 3 is a schematic cross-sectional view parallel to an axial direction of a honeycomb structure according to an embodiment of the present invention;

FIG. 4 is a cross-sectional view schematically showing a cross section parallel to an axial direction of cells having plugged portions and a partition wall of a honeycomb segment according to an embodiment of the present invention;

FIG. 5 is a schematic view of an exhaust gas flow path of an exhaust gas purifying device incorporating a honeycomb structure; and

FIG. 6 is a graph showing results of a heating test for a honeycomb structure according to Example.

### DETAILED DESCRIPTION OF THE INVENTION

Hereinafter, embodiments of a honeycomb structure according to the present invention will be described with reference to the drawing. However, the present invention is not limited to these embodiments, and various changes, modifications, and improvements may be made based on knowledge of those skilled in the art, without departing from the scope of the present invention.

### <1. Honeycomb Structure>

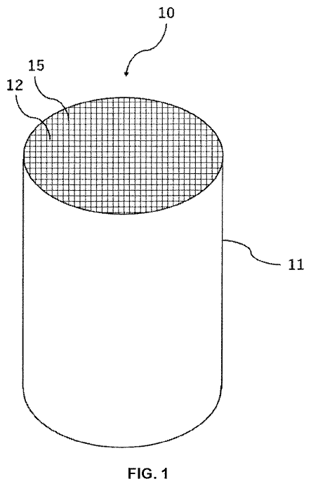

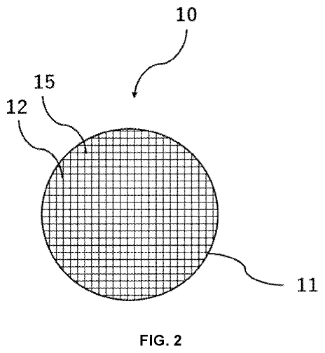

FIG. 1 shows a schematic external view of a pillar shaped honeycomb structure 10 according to an embodiment of the present invention. FIG. 2 shows a schematic cross-sectional view of the honeycomb structure 10 perpendicular to the axial direction. The honeycomb structure 10 includes: an outer peripheral wall 11; and a porous partition wall 12 which is arranged on an inner side of the outer peripheral wall 11 and defines a plurality of cells 15 that extend from one end face to the other end face to form flow paths.

An outer shape of the honeycomb structure 10 may be, but not particularly limited to, a shape such as a pillar shape with circular end faces (cylindrical shape), a pillar shape with oval end faces, and a pillar shape with polygonal (quadrangular, pentagonal, hexagonal, heptagonal, octagonal, and the like) end faces, and the like. Furthermore, the size of the honeycomb structure 10 is not particularly limited, and an axial length of the honeycomb structure is preferably from 40 to 500 mm. Further, for example, when the outer shape of the honeycomb structure 10 is cylindrical, a radius of each end face is preferably from 50 to 500 mm.

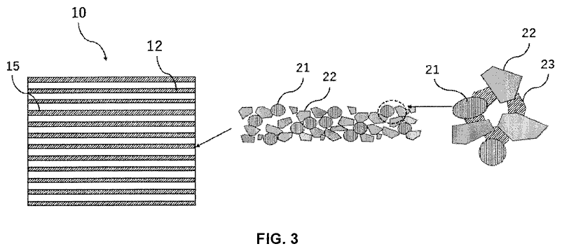

FIG. 3 shows a schematic cross-sectional view of the honeycomb structure 10 parallel to the axial direction. The partition wall of the honeycomb structure 10 is a porous body containing aggregates 22 and binding materials 23 that bind the aggregates 22, and at least a part of the aggregates 22 is composed of magnetic particles 21. According to such a configuration, the temperature of the magnetic particles 21 is increased by induction heating, and its heat increase the temperature of the honeycomb structure 10, thereby allowing carbon particles and the like to be combustion-removed by induction heating or a catalyst supported on the honeycomb structure to be heated. Further, the pressure loss can be well controlled, because the magnetic particles 21 are provided in the partition wall 12, rather than in the cells 15 of the honeycomb structure 10. Furthermore, since the magnetic particles 21 form at least a part of the aggregates 22, the magnetic particles 21 are not configured to be embedded in the partition wall 12, but some of the magnetic particles 21 are present on the surface of the partition wall 12. Such a configuration allows particulate matters to be regenerated to come into direct contact with the magnetic particles 21, resulting in a good particulate matter regeneration function.

All of the aggregates 22 are preferably composed of magnetic particles. Such a configuration can lead to an improved electromagnetic induction heating efficiency of the honeycomb structure 10. Further, it is preferable that from 40 to 100% by volume of the aggregates 22 are composed of the magnetic particles 21, and it is more preferable that from 60 to 100% by volume of the aggregates 22 are composed of the magnetic particles. When the magnetic particles 21 are in an amount of 40% by volume or more of the aggregates 22, it provides larger contribution to eddy current, resulting in further improved heating performance.

The aggregates 22 can be composed of magnetic particles and a ceramic material. The ceramic material forming the aggregates 22 is preferably at least one selected from the group consisting of cordierite, silicon carbide, silicon, aluminum titanate, silicon nitride, mullite, and alumina. More preferably, the ceramic material forming the aggregates 22 is formed from at least one ceramic material selected from the group consisting of silicon carbide, silicon, and silicon nitride, in terms of high thermal conductivity.

The binding materials 23 are preferably metal silicon, cordierite, or glass having heat resistance such as borosilicate glass. It is more preferable that the binding materials have electrical conductivity, because they increase a path for eddy current to flow and contributes to improved heating performance, and metal silicon is even more preferable in this regard.

The partition wall 12 of the honeycomb structure 10 preferably has a thickness of from 0.10 to 0.50 mm, and more preferably from 0.25 to 0.45 mm, in terms of ease of production. For example, the thickness of 0.20 mm or more improves the strength of the honeycomb structure 10. The thickness of 0.50 mm or less can result in lower pressure loss when the honeycomb structure 10 is used as a filter. It should be noted that the thickness of the partition wall 12 is an average value measured by a method for observing the axial cross section with a microscope.

The partition wall 12 of the honeycomb structure 10 preferably has a porosity of 35% or more. The porosity of the partition wall of the honeycomb structure 10 of 35% or more tends to decrease the pressure loss. The porosity of the partition wall 12 of the honeycomb structure 10 is preferably from 35 to 70%, and more preferably from 40 to 65%, in terms of ease of production. The porosity of 70% or less can maintain the strength of the honeycomb structure 10.

Further, the porous partition wall 12 preferably has an average pore size of from 5 to 30 μm, and more preferably from 10 to 25 μm. The average pore size of 5 μm or more can decrease the pressure loss when the honeycomb structure 10 is used as a filter. The average pore size of 30 μm or less can maintain the collecting performance of the honeycomb structure 10. As used herein, the terms “average pore diameter” and “porosity” mean an average pore diameter and a porosity measured by mercury press-in method, respectively.

The honeycomb structure 10 preferably has a cell density in a range of from 5 to 93 cells/cm², and more preferably 5 to 63 cells/cm², and even more preferably in a range of from 31 to 54 cells/cm². The cell density of the honeycomb structure 10 of 5 cells/cm² or more can allow the pressure loss to be easily reduced, and the cell density of 93 cells/cm² or less can allow the strength of the honeycomb structure 10 to be maintained.

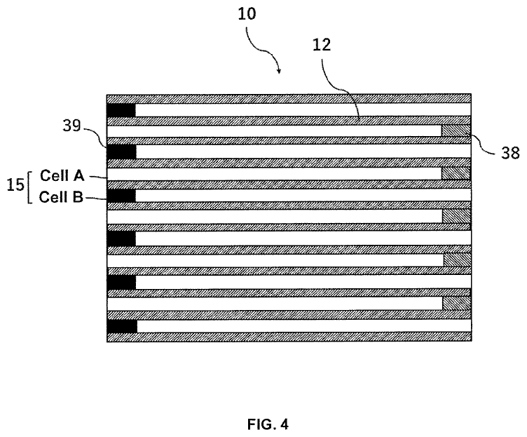

As illustrated in FIG. 4, the honeycomb structure 10 may include: a plurality of cells A which are opened on the one end face side and have plugged portions 38 on the other end face; and a plurality of cells B which are arranged alternately with the cells A, and which are opened on the other end face side and have plugged portions 39 on the one end face. The cells A and the cells B are alternately arranged so as to be adjacent to each other across the partition wall 12, and both end faces form a checkered pattern. The numbers, arrangements, shapes and the like of the cells A and B, are not limited, and they may be appropriately designed as needed. Such a honeycomb structure 10 can be used as a filter (honeycomb filter) for purifying an exhaust gas. It should be noted that when the honeycomb structure 10 is not used as the honeycomb filter, the plugged portions 38, 39 may not be provided.

The honeycomb structure 10 according to the present embodiment may have a catalyst supported on the surface of the partition wall 12 and/or in pores of the partition wall 12.

A type of the catalyst is not particularly limited, and it can be appropriately selected according to the use purposes and applications of the honeycomb structure 10. Examples of the catalyst include noble metal catalysts or other catalysts. Illustrative examples of the noble metal catalysts include a three-way catalyst and an oxidation catalyst obtained by supporting a noble metal such as platinum (Pt), palladium (Pd) and rhodium (Rh) on surfaces of pores of alumina and containing a co-catalyst such as ceria and zirconia, or a NOₓ storage reduction catalyst (LNT catalyst) containing an alkaline earth metal and platinum as storage components for nitrogen oxides (NOₓ). Illustrative examples of a catalyst that does not use the noble metal include a NOₓ selective reduction catalyst (SCR catalyst) containing a copper-substituted or iron-substituted zeolite, and the like. Also, two or more catalysts selected from the group consisting of those catalysts may be used. A method for supporting the catalyst is not particularly limited, and it can be carried out according to a conventional method for supporting the catalyst on the honeycomb structure.

The honeycomb structure 10 may have a surface layer(s) having permeability on at least a part of the surface of the partition wall 12. As used herein, the expression “having permeability” means that a permeability of the surface layer is 1.0×10⁻¹³ m² or more. From the viewpoint of further reducing the pressure loss, the permeability is preferably 1.0×10⁻¹² m² or more. Since the surface layer has the permeability, the pressure loss of the honeycomb structure 10 caused by the surface layer can be suppressed.

Further, as used herein, the “permeability” refers to a physical property value calculated by the following equation (1), which value is an index indicating passing resistance when a certain gas passes through an object (partition wall 12). Here, in the following equation (1), C represents a permeability (m²), F represents a gas flow rate (cm³/s), T represents a thickness of a sample (cm), V represents a gas viscosity (dynes·sec/cm²), D represents a diameter of a sample (cm), P represents a gas pressure (PSI). The numerical values in the following equation (1) are: 13.839 (PSI)=1 (atm) and 68947.6 (dynes·sec/cm²)=1 (PSI).

$$\begin{matrix}[ Equation 1 ] & \\ C = \frac{8 FTV}{{π D}^{2} ( {P}^{2} - {13.839}^{2} ) / 13.839 \times 68947.6} \times {10}^{- 4} & ( 1 )\end{matrix}$$

When measuring the permeability, the partition wall 12 with the surface layer is cut out, the permeability is measured on the partition wall 12 with the surface layer, and the permeability is then measured on the partition wall 12 from which the surface layer has been removed. From a ratio of thicknesses of the surface layer and the partition wall and from the permeability measurement results, the permeability of the surface layer is calculated.

The surface layer preferably has a porosity of 50% or more, and more preferably 60% or more, and still more preferably 70% or more. By having the porosity of 50% or more, the pressure loss can be suppressed. However, if the porosity is too high, the surface layer becomes brittle and easily peels off. Therefore, the porosity is preferably 90% or less.

As a method of measuring the porosity of the surface layer by the mercury press-in method, a difference between a mercury porosity curve of a sample having a substrate and surface layer and a mercury porosity curve of only the substrate from which only the surface layer has been scrapped off and removed is determined to be a mercury porosity curve of the surface layer, and the porosity of the surface layer is calculated from the mass of the scraped surface layer and the mercury porosity curve. A SEM image may be taken, and the porosity of the surface layer may be calculated from an area ratio of the void portions and the substantive portions by image analysis of the surface layer portion.

The surface layer preferably has an average pore diameter of 10 μm or less, and more preferably 5 μm or less, and further preferably 4 μm or less, and particularly preferably 3 μm or less. The average pore diameter of 10 μm or less can achieve a higher particulate collecting efficiency. However, if the average pore diameter of the surface layer is too low, the pressure loss will increase. Therefore, the average pore diameter is preferably 0.5 μm or more.

As a method of measuring the average pore diameter of the surface layer by the mercury press-in method, in the form of peak values in the mercury porosimeter, a difference between a mercury porosity curve (pore volume frequency) on the substrate on which the surface layer is formed and a mercury porosity curve on only the substrate from which only the surface layer has been scrapped off and removed is determined to be a mercury porosity curve of the surface layer, and its peak is determined to be the average pore diameter. Further, an SEM image of the cross section of the honeycomb structure 10 may be taken, and the surface layer portion may be subject to image analysis to binarize the void portions and the substantive portions, and twenty or more voids may be randomly selected to average the inscribed circles, and the average may be determined to be the average pore diameter.

Further, the thickness of the surface layer is not particularly limited. However, in order to obtain the effect of the surface layer more remarkably, the thickness of the surface layer is preferably 10 μm or more. On the other hand, from the viewpoint of avoiding an increase in pressure loss, the thickness of the surface layer is preferably 80 μm or less. The thickness of the surface layer is more preferably 50 μm or less. For a method of measuring the thickness of the surface layer, for example, the honeycomb structure 10 on which the surface layer is formed is cut in a direction perpendicular to the extending direction of the cells 15, and the thickness of the surface layer is measured from the cross section of the honeycomb structure 10, and the measured thicknesses at arbitrary five points can be averaged.

The aggregates 22 containing the magnetic particles 21 in the partition wall 12 of the honeycomb structure 10 may be provided in the entire partition wall 12 or in some regions of the partition wall 12. When the aggregates 22 containing the magnetic particles 21 are provided in the entire honeycomb structure 10 in the axial direction, the induction heating efficiency of the honeycomb structure 10 will be more improved. When the aggregates 22 containing the magnetic particles 21 are provided in a part of the honeycomb structure 10 in the axial direction, for example, when they are provided in a region on an inlet side of the gas flow path of the honeycomb structure 10, the entire honeycomb structure 10 can be efficiently heated, because the gas heated at a starting position of the gas flow proceeds to an outlet side of the honeycomb structure 10. Further, since soot tends to be accumulated at the outlet side of the gas flow path of the honeycomb structure 10, the soot accumulated in the honeycomb structure 10 can be more effectively removed when the aggregates 22 containing the magnetic particles 21 are provided in the region on the outlet side. Furthermore, when the aggregates 22 containing the magnetic particles 21 are provided in a part of the honeycomb structure 10 in the axial direction, a coil wiring provided on the outer periphery of the honeycomb structure 10 can be made compact when the honeycomb structure 10 is used as an exhaust gas purifying device.

It is preferable that the content of the magnetic particles 21 is from 30 to 70% by volume relative to the total volume of the partition wall 12. The content of the magnetic particles 21 of 30% or more by volume relative to the total volume of the partition wall 12 can provide an improved electromagnetic induction heating efficiency of the honeycomb structure 10. The content of the magnetic particles 21 of 70% or less relative to the total volume of the partition wall 12 can reduce performance as a base material, especially Young's modulus, and ensure thermal shock resistance.

The magnetic particles 21 preferably have a Curie point of 450° C. or more. The Curie point of 450° C. or more of the magnetic particles can allow a honeycomb temperature to reach a temperature sufficient to increase a catalyst temperature of a catalyst provided on the honeycomb temperature 10 to its catalyst activation temperature or higher, as well as this can lead to an ease to burn out and remove PMs (particulate matters) collected in the cells 15 to regenerate a honeycomb structure filter. The magnetic substance having a curry point of 450° C. or more includes, for example, the balance Co-20% by mass of Fe; the balance Co-25% by mass of Ni-4% by mass of Fe; the balance Fe-15-35% by mass of Co; the balance Fe-17% by mass of Co-2% by mass of Cr-1% by mass of Mo; the balance Fe-49% by mass of Co-2% by mass of V; the balance Fe-18% by mass of Co-10% by mass of Cr-2% by mass of Mo-1% by mass of Al; the balance Fe-27% by mass of Co-1% by mass of Nb; the balance Fe-20% by mass of Co-1% by mass of Cr-2% by mass of V; the balance Fe-35% by mass of Co-1% by mass of Cr; pure cobalt; pure iron; electromagnetic soft iron; the balance Fe-0.1-0.5% by mass of Mn; the balance Fe-3% by mass of Si; the balance Fe-6.5% by mass of Si; the balance Fe-18% by mass of Cr; the balance Ni-13% by mass of Fe-5.3% by mass of Mo; the balance Fe-45% by mass of Ni; and the like. Here, the Curie point of the magnetic substance refers to a temperature at which a ferromagnetic property is lost.

The magnetic particles 21 preferably have an intrinsic resistance value of 20 μΩcm or more at 25° C. According to such a configuration, an amount of heat generated by induction heating can be further increased. Examples of the magnetic substance having an intrinsic resistance value of 20 μΩcm or more at 25° C. include the balance Fe-18% by mass of Cr; the balance Fe-13% by mass of Cr-2% by mass of Si; the balance Fe-20% by mass of Cr-2% by mass of Si-2% by mass of Mo; the balance Fe-10% by mass of Si-5% by mass of Al; the balance Fe-18% by mass of Co-10% by mass of Cr-2% by mass of Mo-1% by mass of Al; the balance Fe-36% by mass of Ni; the balance Fe-45 by mass of Ni; the balance Fe-49% by mass of Co-2% by mass of V; the balance Fe-18% by mass of Co-10% by mass of Cr-2% by mass of Mo-1% by mass of Al; the balance Fe-17% by mass of Co-2% by mass of Cr-1% by mass of Mo; and the like.

The magnetic particles 21 preferably have a maximum magnetic permeability of 1000 or more. According to such a configuration, when the honeycomb structure 10 is dielectrically heated, the temperature can be raised in a short period of time until a temperature at which water vaporizes (about 100° C.), and further until a temperature at which the catalyst is activated (about 300° C.). Examples of the magnetic substance having a maximum magnetic permeability of 1000 or more include the balance Fe-10% by mass of Si-5% by mass of Al; 49% by mass of Co-49% by mass of Fe-2% by mass of V; the balance Fe-36% by mass of Ni; the balance Fe-45% by mass of Ni; the balance Fe-35% by mass of Cr; the balance Fe-18% by mass of Cr; and the like.

The magnetic particles 21 are magnetized by a magnetic field, and a state of magnetization varies depending on the intensity of the magnetic field. This is represented by a “magnetization curve”. The magnetization curve may have a magnetic field H on a horizontal axis and a magnetic flux density B on a vertical axis (B-H curve). A state where no magnetic field is applied to the magnetic substance refers to a degaussing state, which is represented by an origin O. As a magnetic field is applied, a curve in which the magnetic flux density increases from the origin O to a saturated state is drawn. This curve is an “initial magnetization curve”. A slope of a straight line connecting a point on the initial magnetization curve to the origin is a “permeability”. The permeability indicates an ease of magnetization of the magnetic substance in such a sense that the magnetic field permeates. The magnetic permeability near the origin where the magnetic field is smaller is an “initial magnetic permeability”, and a magnetic permeability that is maximum on the initial magnetization curve is a “maximum magnetic permeability”.

Although a material of the outer peripheral wall 11 of the honeycomb structure 10 are not particularly limited, the honeycomb structure 10 is required to be a porous body having a large number of pores. Therefore, the honeycomb structure 10 is typically formed of a ceramic material. Examples of the ceramic material include a sintered body of cordierite, silicon carbide, aluminum titanate, silicon nitride, mullite, alumina, a silicon-silicon carbide-based composite material, or silicon carbide-cordierite based composite material, in particular, a sintered body mainly based on a silicon-silicon carbide composite material or silicon carbide. As used herein, the expression “silicon carbide-based” means that the outer peripheral wall 11 contains silicon carbide in an amount of 50% by mass or more of the entire outer peripheral wall 11. The phrase “the outer peripheral wall 11 is mainly based on a silicon-silicon carbide composite material” means that the outer peripheral wall 11 contains 90% by mass or more of the silicon-silicon carbide composite material (total mass) based on the entire outer peripheral wall 11. Here, for the silicon-silicon carbide composite material, it contains silicon carbide particles as an aggregate and silicon as a binding material for binding the silicon carbide particles, and a plurality of silicon carbide particles are preferably bonded by silicon so as to form pores between the silicon carbide particles. The phrase “the outer peripheral wall 11 is mainly based on silicon carbide” means that the outer peripheral wall 11 contains 90% by mass or more of silicon carbide (total mass) based on the entire outer peripheral wall 11.

The outer peripheral wall 11 of the honeycomb structure 10 is a porous body containing the aggregates 22 and the binding materials 23 that bind the aggregates 22, and at least a part of the aggregates 22 is preferably composed of the magnetic particles 21. Such a configuration can provide an improved electromagnetic induction heating efficiency of the honeycomb structure 10. The aggregates 22, the binding materials 23, and the magnetic particles 21 that form the outer peripheral wall 11 can be of the same type and used in the same contents as those used in the partition wall 12 described above.

It should be noted that the honeycomb structure 10 is not limited to the integrated honeycomb structure 10 in which the partition wall 12 is integrally formed. For example, it may be a honeycomb structure having a structure in which honeycomb segments each having the porous partition wall 12 that defines a plurality of cells 15 serves as flow paths for a fluid are combined via joining material layers (a joined honeycomb structure). The honeycomb structure in which the honeycomb segments are joined can be produced, for example, as follows.

First, a joining material is applied to joining surfaces (side surfaces) of each honeycomb segment while attaching joining material adhesion preventing masks to both end faces of each honeycomb segment. These honeycomb segments are then arranged adjacent to each other such that the side surfaces of the honeycomb segments are opposed to each other, and the adjacent honeycomb segments are pressure-bonded together, and then heated and dried. Thus, the honeycomb structure in which the side surfaces of the adjacent honeycomb segments are joined via the joining materials is produced. For the honeycomb structure, the outer periphery may be ground to a desired shape (e.g., cylindrical), and the outer peripheral surface may be coated with a coating material, and then heated and dried to form the outer peripheral wall.

The material of the joining material adhesion preventing mask that can be suitably used herein includes, but not particularly limited to, synthetic resins such as polypropylene (PP), polyethylene terephthalate (PET), polyimide, or Teflon (Registered Trademark), and the like. Further, the mask is preferably provided with an adhesive layer, and the material of the adhesive layer is preferably an acrylic resin, a rubber (for example, a rubber mainly based on a natural rubber or a synthetic rubber), or a silicon resin.

Examples of the joining material adhesion preventing mask that can be suitably used herein include a pressure sensitive adhesive film having a thickness of from 20 to 50 μm.

The joining material can be prepared by mixing, for example, ceramics powder, a dispersant (e.g., water), and optionally additives such as inorganic binders, organic binders, ceramic fibers, agglutinants, and foaming resins. The ceramics are preferably those containing at least one selected from cordierite, mullite, zircon, aluminum titanate, silicon carbide, silicon nitride, zirconia, spinel, indialite, sapphirine, corundum, and titania, and more preferably having the same material as that of the honeycomb structure. The inorganic binders include colloidal particles such as colloidal silica and colloidal alumina, and the organic binders include polyvinyl alcohol, methyl cellulose, CMC (carboxymethyl cellulose) and the like. The ceramic fibers that can be suitably used herein include alumina fibers, magnesium silicate fibers, and the like, conforming to REACH regulations.

The honeycomb structure 10 may have a coating layer on the outer peripheral surface. A material making up the coating layer is not particularly limited, and various known coating materials including aggregates, inorganic binders and the like can be appropriately used. When the outer peripheral surface is provided with the coating layer, the coating layer will form the outer peripheral wall. The coating material may further contain colloidal silica, an organic binder, clay and the like. The organic binder is preferably used in an amount of from 0.05 to 0.5% by mass, and more preferably from 0.1 to 0.2% by mass. Further, the clay is preferably used in an amount of from 0.2 to 2.0% by mass, and more preferably from 0.4 to 0.8% by mass.

### <2. Method for Producing Honeycomb Structure>

The method for producing the honeycomb structure 10 will be described in detail. First, the honeycomb structure having the porous partition wall and the plurality of cells defined by the partition wall is produced. For example, when producing the honeycomb structure by forming the aggregates for the partition wall from the magnetic particles and the ceramics material (which is cordierite), a cordierite-forming raw material is firstly prepared. The cordierite-forming raw material contains a silica source component, a magnesia source component, and an alumina source component, and the like, in order to formulate each component so as to have a theoretical composition of cordierite crystal. Among them, the silica source component that can be preferably used herein includes quartz and fused silica, and the particle diameter of the silica source component is preferably from 100 to 150 μm.

Examples of the magnesia source component include talc and magnesite. Among them, talc is preferred. The talc is preferably contained in an amount of from 37 to 43% by mass in the cordierite-forming raw material. The talc preferably has a particle diameter (average particle diameter) of from 5 to 50 μm, and more preferably from 10 to 40 μm. Further, the magnesia (MgO) source component may contain Fe₂O₃, CaO, Na₂O, K₂O and the like as impurities.

The alumina source component preferably contains at least one of aluminum oxide and aluminum hydroxide, in terms of fewer impurities. Further, aluminum hydroxide is preferably contained in an amount of from 10 to 30% by mass, and aluminum oxide is preferably contained in an amount of from 0 to 20% by mass, in the cordierite-forming raw material.

Further, the magnetic particles are mixed with the cordierite forming raw material such that the magnetic particles is contained at a desired percentage relative to the total volume of the partition wall.

A material for a green body to be added to the cordierite-forming raw material (additive) is then prepared. At least a binder and a pore former are used as additives. In addition to the binder and the pore former, a dispersant or a surfactant can be used.

The pore former that can be used includes a substance that can be oxidatively removed by reacting with oxygen at a temperature equal to or lower than a firing temperature of cordierite, or a low melting point reactant having a melting point at a temperature equal to or lower than the firing temperature of cordierite, or the like. Examples of the substance that can be oxidatively removed include resins (particularly particulate resins), graphite (particularly particulate graphite) and the like. Examples of the low melting point reactant that can be used include at least one metal selected from the group consisting of iron, copper, zinc, lead, aluminum, and nickel, alloys mainly based on those metals (e.g., carbon steel or cast iron for iron, stainless steel), or alloys mainly based on two or more of those metals. Among them, the low melting point reactant is preferably an iron alloy in the form of powder or fiber. Further, the low melting point reactant preferably has a particle diameter or a fiber diameter (an average diameter) of from 10 to 200 μm. Examples of a shape of the low melting point reactant include a spherical shape, a wound-lozenge shape, a confetii shape, and the like. These shapes are preferable because the shape of the pores can be easily controlled.

Examples of the binder include hydroxypropylmethyl cellulose, methyl cellulose, hydroxyethyl cellulose, carboxymethyl cellulose, polyvinyl alcohol and the like. Further, examples of the dispersant include dextrin, polyalcohol and the like. Furthermore, examples of the surfactant include fatty acid soaps. The additive may be used alone or in combination of two or more.

Subsequently, to 100 parts by mass of the cordierite-forming raw material are added from 3 to 8 parts by mass of the binder, from 3 to 40 parts by mass of the pore former, from 0.1 to 2 parts by mass of the dispersant, and from 10 to 40 parts by mass of water, and these materials for a green body are kneaded to prepare a green body.

The prepared green body is then formed into a honeycomb shape by an extrusion molding method, an injection molding method, a press molding method, or the like to obtain a raw honeycomb formed body. The extrusion molding method is preferably employed, because continuous molding is easy, and, for example, cordierite crystals can be oriented. The extrusion molding method can be performed using an apparatus such as a vacuum green body kneader, a ram type extrusion molding machine, a twin-screw type continuous extrusion molding machine, or the like.

The honeycomb formed body is then dried and adjusted to a predetermined size to obtain a honeycomb dried body. The honeycomb formed body can be dried by hot air drying, microwave drying, dielectric drying, drying under reduced pressure, vacuum drying, freeze drying and the like. It is preferable to perform combined drying of the hot air drying and the microwave drying or dielectric drying, because the entire honeycomb formed body can be rapidly and uniformly dried.

The honeycomb dried body is then fired to provide a honeycomb structure. After firing, a heat treatment can be carried out in atmosphere at a temperature lower than the firing temperature to form oxide films on the particle surfaces in advance. As a result, it is possible to suppress any aging due to oxidation during use. Further, when the resulting honeycomb structure is produced in a state where the outer peripheral wall is formed on the outer peripheral surface of the honeycomb structure, the outer peripheral surface may be left as the outer peripheral wall, or the outer peripheral surface may be ground to remove the outer peripheral wall. The coating material may be applied to the outer periphery of the honeycomb structure from which the outer peripheral wall has thus been removed, in a subsequent step, to form a coating layer. In this case, the coating layer will form the outer peripheral wall. Further, when grinding the outer peripheral surface, a part of the outer peripheral wall may be ground and removed, and on that part, the coating layer may be formed by the coating material. In this case, the remaining outer peripheral wall and coating layer will form the outer peripheral wall.

When preparing the coating material, it can be prepared using, for example, a biaxial rotary type vertical mixer. Further, the coating material may further contain colloidal silica, an organic binder, clay and the like. The content of the organic binder is preferably from 0.05 to 0.5% by mass, and more preferably from 0.1 to 0.2% by mass. The content of the clay is preferably from 0.2 to 2.0% by mass, and more preferably from 0.4 to 0.8% by mass.

The coating material is applied onto the outer peripheral surface of the honeycomb structure, and the applied coating material is dried to form the coating layer. Such a structure can allow for effective suppression of cracking in the coating layer during the drying and the heat treatment.

Examples of a coating method for the coating material can include a method for applying the coating material by placing the honeycomb structure on a rotating table and rotating it, and pressing a blade-shaped applying nozzle along the outer peripheral portion of the honeycomb structure while discharging the coating material from the applying nozzle. Such a configuration can allow the coating material to be applied with a uniform thickness. Further, this method can lead to a decreased surface roughness of the formed coating layer, and can result in a coating layer that has an improved appearance and is difficult to be broken by thermal shock.

The method for drying the applied coating material is not limited, but in terms of preventing dry-cracking, it can suitably use, for example, a method of drying 25% or more of a water content in the coating material by maintaining the coating material at room temperature for 24 hours or more, and then maintaining it in an electric furnace at 600° C. for 1 hour or more to remove moisture and organic matters.

When supporting the catalyst on the honeycomb structure, the method for supporting the catalyst is not particularly limited and it can be carried out according to the method for supporting the catalyst carried out in the conventional method for producing the honeycomb structure.

### <3. Exhaust Gas Purifying Device>

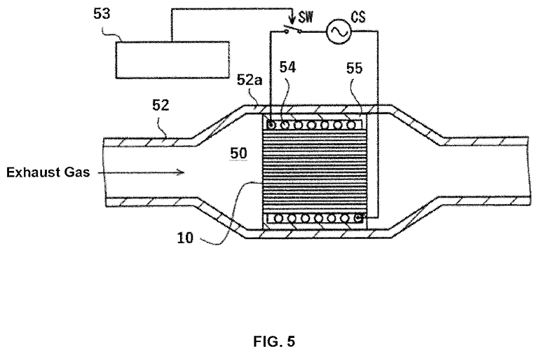

Using the honeycomb structure according to the embodiment of the present invention as described above, an exhaust gas purifying device can be formed. As an example, FIG. 5 shows a schematic view of an exhaust gas flow path of an exhaust gas purifying device 50 including the honeycomb structure 10. The exhaust gas purifying device 50 includes the honeycomb structure 10 and a coil wiring 54 that spirally surrounds the outer periphery of the honeycomb structure 10. Also, the exhaust gas purifying device 50 has a metal pipe 52 for housing the honeycomb structure 10 and the coil wiring 54. The exhaust gas purifying device 50 can be arranged in an increased diameter portion 52a of the metal pipe 52. The coil wiring 54 may be fixed to the interior of the metal pipe 52 by a fixing member 55. The fixing member 55 is preferably a heat-resistant member such as ceramic fibers. The honeycomb structure 10 may support a catalyst.

The coil wiring 54 is spirally wound around the outer periphery of the honeycomb structure 10. It is also assumed that two or more coil wirings 54 are used. An AC current supplied from an AC power supply CS flows through the coil wiring 54 in response to turning on (ON) of a switch SW, and as a result, a magnetic field that periodically changes is generated around the coil wiring 54. The on/off of the switch SW is controlled by a control unit 53. The control unit 53 can turn on the switch SW in synchronization with the start of an engine and pass an alternating current through the coil wiring 54. It is also assumed that the control unit 53 turns on the switch SW regardless of the start of the engine (for example, in response to an operation of a heating switch pushed by a driver).

In the present disclosure, a temperature of the honeycomb structure 10 is increased in response to the change of the magnetic field according to the alternating current flowing through the coil wiring 54. Based on this, carbon fine particles and the like collected by the honeycomb structure 10 are burned out. Also, when the honeycomb structure 10 supports the catalyst, the increase in the temperature of the honeycomb structure 10 raises a temperature of the catalyst supported by the catalyst support contained in the honeycomb structure 10 and promotes the catalytic reaction. Briefly, carbon monoxide (CO), nitrogen oxide (NOₓ), and hydrocarbon (CH) are oxidized or reduced to carbon dioxide (CO₂), nitrogen (N₂), and water (H₂O).

### EXAMPLES

Hereinafter, the present invention will be specifically described based on Examples. However, the present invention is not limited to Examples.

### Example 1

Silicon carbide as the aggregate, metal particles having a composition of the balance Fe-17% by mass of Co-2% by mass of Cr-1% by mass of Mo, and metal silicon as the binding material were blended in a mass ratio of 22:67:11, and methyl cellulose as an organic binder, a surfactant, and water were added, uniformly mixed and kneaded to prepare a forming material. The resulting forming material was then extruded using an extrusion molding machine to obtain a honeycomb formed body. Subsequently, the obtained honeycomb formed body was cut, dried and then plugged, and sintered at a predefined sintering temperature to obtain a segmental honeycomb having 42 mm square. The segmental honeycombs were joined together using a joining material prepared by mixing silicon carbide, colloidal silica, alumina fibers, a foaming resin, and carboxymethyl cellulose as an organic binder to form a joined body, and the outer periphery of the joined body was then ground to have a diameter of 82 mm to obtain a honeycomb structure which was a joined body of a plurality of segments.

Further, the side surface of the segment honeycomb structure was subjected to an outer peripheral coating prepared by mixing silicon carbide, colloidal silica, and carboxymethyl cellulose as an organic binder to produce a honeycomb structure.

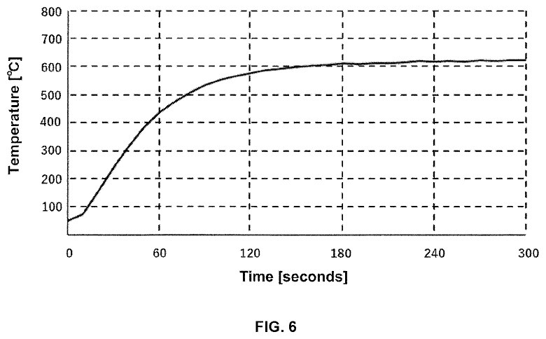

Subsequently, a heating test of the honeycomb structure was conducted with an induction heating coil having a diameter of 100 mm using an induction heating device, and a temperature of the end face of the honeycomb structure was measured with an infrared thermometer. The heating performance of the honeycomb structure was measured at an input power of 14 kW, and at an induction heating frequency of 30 kHz. FIG. 6 shows a graph showing a relationship between a time (seconds) and a temperature (° C.).

### DESCRIPTION OF REFERENCE NUMERALS

10 honeycomb structure
11 outer peripheral wall
12 partition wall
15 cell
21 magnetic particles
22 aggregate
23 binding material
38, 39 plugged portion
50 exhaust gas purifying device
52 metal pipe
53 control unit
54 coil wiring
55 fixing member

1. A pillar shaped honeycomb structure, comprising:
an outer peripheral wall; and
a porous partition wall disposed on an inner side of the outer peripheral wall, the partition wall defining a plurality of cells, each of the plurality of cells extending from one end face to the other end face to form a flow path,
wherein the partition wall is a porous body comprising aggregates and binding materials binding the aggregates, and
wherein at least a part of the aggregates comprises magnetic particles.

2. The honeycomb structure according to claim 1,
wherein the outer peripheral wall is a porous body comprising the aggregates and the binding materials binding the aggregates, and
wherein at least a part of the aggregates comprises the magnetic particles.

3. The honeycomb structure according to claim 1, wherein all of the aggregates comprises the magnetic particles.

4. The honeycomb structure according to claim 1, wherein the aggregates comprise magnetic particles and a ceramic material.

5. The honeycomb structure according to claim 4, wherein the ceramic material is at least one selected from cordierite, silicon carbide, silicon, aluminum titanate, silicon nitride, mullite, and alumina.

6. The honeycomb structure according to claim 1, wherein the porous body has a porosity of 35% or more.

7. The honeycomb structure according to claim 1, wherein the magnetic particles are contained at 30 to 70% by volume relative to the total volume of the partition wall.

8. The honeycomb structure according to claim 1, wherein the magnetic particles have a Curie point of 450° C. or more.

9. The honeycomb structure according to claim 1, wherein the magnetic particles have an intrinsic resistance value of 20 μΩcm or more at 25° C.

10. The honeycomb structure according to claim 1, wherein the magnetic particles have a maximum magnetic permeability of 1000 or more.

11. An exhaust gas purifying device, comprising:
the honeycomb structure according to claim 1;
a coil wiring that spirally surrounds an outer periphery of the honeycomb structure; and
a metal pipe for housing the honeycomb structure and the coil wiring.
